(19) United States
(12) Patent Application Publication
(10) Pub. No.: US 2002/0093576 A1
(43) Pub. Date: Jul. 18, 2002

(54) Passive control system for taking a three-dimensional picture

(76) Inventors: Chih-Chin Hsu, Taipei (TW); Chao-Ching Ho, Taipei (TW); Zhi-Zhen Chiang, Taipie (TW); Tsung-Chieh Huang, Taipei (TW); Wen-Liang Hsiao, Taipei (TW); Wen-Ching Chen, Taipei (TW); Shiann-Jang Wang, Taipei (TW); Cheng-Hung Chi, Taipei (TW); Yi-Chuan Wang, Taipei (TW); Kuo-Hsin Lee, Taipei (TW); Wen-Chih Tai, Taipei (TW)

Correspondence Address: Dougherty & Troxell, ONE SKYLINE PLACE, 5205 LEESBURG PIKE, SUITE 1404, FALLS CHURCH, VA, 22041, US

(21) Appl. No.: 09/938,740

(22) Filed: Aug. 27, 2001

(30) Foreign Application Priority Data
Jan. 18, 2001 (TW) 90200994

(51) Int. Cl. H04N 5/262

(52) U.S. Cl. 348/239

(57) ABSTRACT

A passive control system for taking a three dimensional picture comprises a 2D-3D converting device, and a rotary disk apparatus. The 2D-3D converting device at one end thereof connects with a digital picture taking apparatus via a shift interface and at the other end thereof connects with a data processing center. The 2D-3D converting device provides a preset program to regulate the digital picture taking apparatus with a start of scanning at a preset time. The rotary disk apparatus provides a positioning interface to connect with a rotary disk thereof and the rotary disk is able to stay in place after turning a preset angular displace in accordance with the preset program. An object to be taken a picture is placed on the rotary disk and is taken a picture by the digital picture taking apparatus as soon as the rotary disk is turned the preset angular displacement once. Then, a generated 2D signal is shifted to a 3D signal by way of the 2D-3D converting device for being treated as a 3D image by the data processing center.

### BACKGROUND OF THE INVENTION

1. Field of the Invention

The present invention relates to a passive control system for taking a three-dimensional picture, and particularly, to a control system, which may integrate a relationship between a digital picture taking apparatus and an object to be taken a picture continuously through a programmable treatment and further inputs a 2d image obtained for being treated as an output of a three-dimensional image.

2. Description of Related Art

The so-called three-dimensional image is formed by way of a digital picture taking apparatus scanning and taking pictures from an object along various orientations to obtain a series of digital two-dimensional images first. Then, the digital two-dimensional images are treated by way of parameters received from a special designed correction card to formed a digitalized three-dimensional images for further use such as being displayed, printed, and etc. Wherein, the two-dimensional (2D) images being shifted to the three-dimensional (3D) image is treated in a computer, and there are various modes developed for the 2D being changed to 3D.

In order to reach a three-dimensional image through the two-dimensional picture taken, it is necessary to equip at least a digital picture taking apparatus, a rotary disk for placing the object. The rotary disk is turned with different rotation angles with respect to different time intervals such that the digitalized two-dimensional images can be taken sequentially. In the mean time, the light source can be provided when necessary to enhance the effect of a preferred picture taking. Of course, the digital files obtained from the procedure of picture taking have to be treated by way of the CPU and related processing software before the three-dimensional image being formed.

Because there is a relationship of interaction between these devices, it is hard to have a uniform effect of picture taking if there is no automatic programmable control available and it is unfavorable for an operation concerning the optics extremely. Although some of the makers have developed a device to control the movement of the rotary disk relative to the camera for certain specific digital picture taking apparatus, it is not a good alternative for solving the problem of picture taking in this field if there is no device compatible with various digital picture taking apparatuses.

### SUMMARY OF THE INVENTION

An object of the present invention is to provide a passive control system for taking a three-dimensional picture, which offers an automatic programmable control to enhance the uniformity of relationship between the devices used in the control system so as to obtain a best quality of three-dimensional image during being formed by way of the two-dimensional images.

### BRIEF DESCRIPTION OF THE DRAWINGS

The present invention can be more fully understood by reference to the following description and accompanying drawings, in which:

FIG. 1 is a system block diagram of a passive control system for taking a three-dimension picture according to the present invention;

FIG. 2 is a flow chart illustrating the process performed by the passive control system for taking a three-dimensional picture according to the present invention;

FIG. 3 is a perspective view of a correction card for adjusting a three-dimension picture used in the present invention;

FIG. 4 is a plan view with regard to a layout of apparatuses used in the passive control system for taking three- dimension picture; and

FIG. 5 is a perspective view constituted based on FIG. 4.

### DETAILED DESCRIPTION OF THE PREFERRED EMBODIMENTS

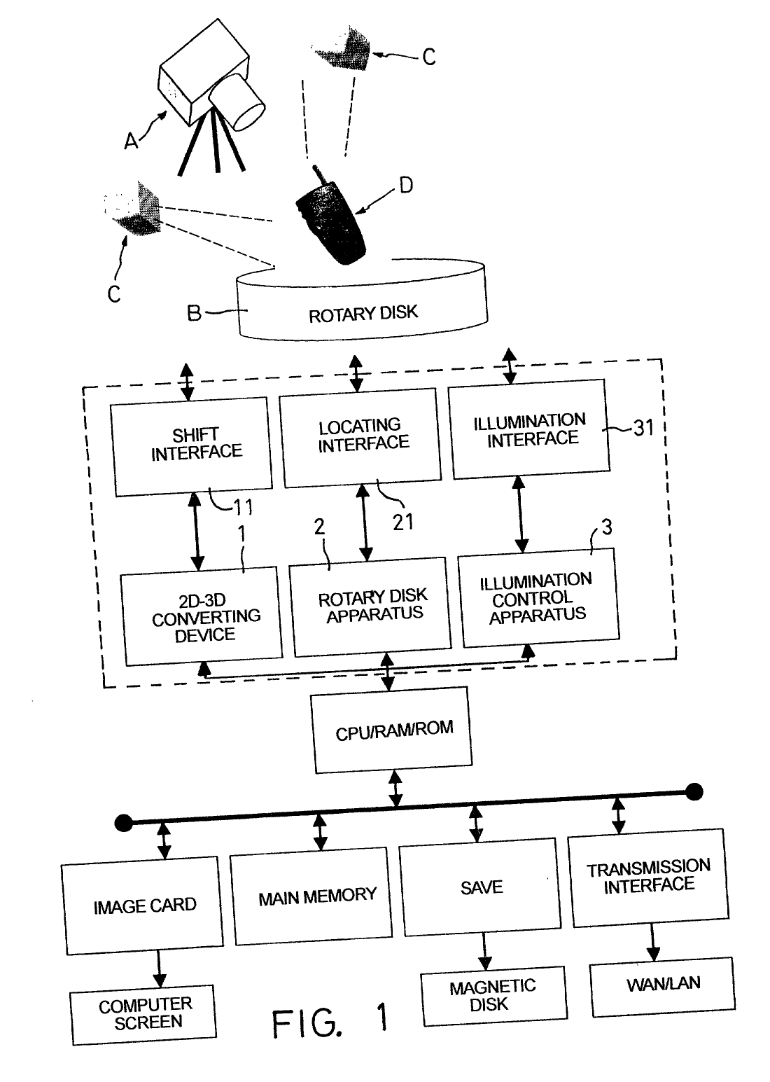

Referring to FIG. 1, a hardware provided in the passive control system for taking three-dimension picture according to the present invention can be set up independently or can be in conjunction with a CPU/RAM/ROM. The hardware comprises a 2D-3D converting device 1, a rotary disk apparatus 2, and/or an illumination control apparatus 3.

Wherein, 2D-3D converting device 1 may be joined to a drive software of the CPU so as to be linked in operation and the 2D-3D converting device 1 has a shift interface 11 to connect with an output port of a digital picture taking apparatus A The shift interface 11 can be a USB port, a 1394 port, or a RS232, that is, one of these three types of ports can be chosen as the shift interface 11 based on the actual need. Thus, while the external digital picture taking apparatus A is in a state of taking a picture, an image signal can be input to treat 2D and 3D signals before the 2D and 3D signals can be entering CPU/RAM/ROM for further use.

The rotary disk control apparatus 2 provides a programmable control with regard to a rotation and a position of the rotary disk, that is, the rotary disk control is compatible with the operation of picture taking performed by the 2D-3D converting device 1 to provides a function of turning the rotary disk 2 orderly. An object to be taken a picture is placed on the rotary disk and linked with hardware of the rotary disk B via a locating interface 21 and the interface 21 can be achieved by way of the USB port, the 1394 port, and the RS232 port, that is, the rotary disk control can be joined to one of the three ports for executing the control. The rotation and the position of the rotary disk can be controlled by a preset program, for instance, every 30° can be set a position respectively during the rotary disk being in a state of turning, and it can be actuated alternatively in the 2D-3D converting device 1. It means the rotary disk can rotate 30° after the digital picture taking apparatus A takes the picture.

The illumination control apparatus 3 is used for controlling the intensity of illumination so that a light source is provided to offer the object to be taken picture a sufficient intensity of illumination for the digital picture taking apparatus A during taking a picture. The digital picture taking apparatus A at both sides thereof has an illumination device C respectively to project the light source toward an object to be scanned so as to obtain a best digital image signal and to lower down the possibility of an erroneous judgment resulting from measuring the noise signal. The illumination control apparatus 3 has an illumination interface 31 to connect with the illumination device C, that is, the illumination interface 31 can connect with the illumination device C via one of the USB port, the 1394 port, and the RS232 port such that the signal can be transmitted.

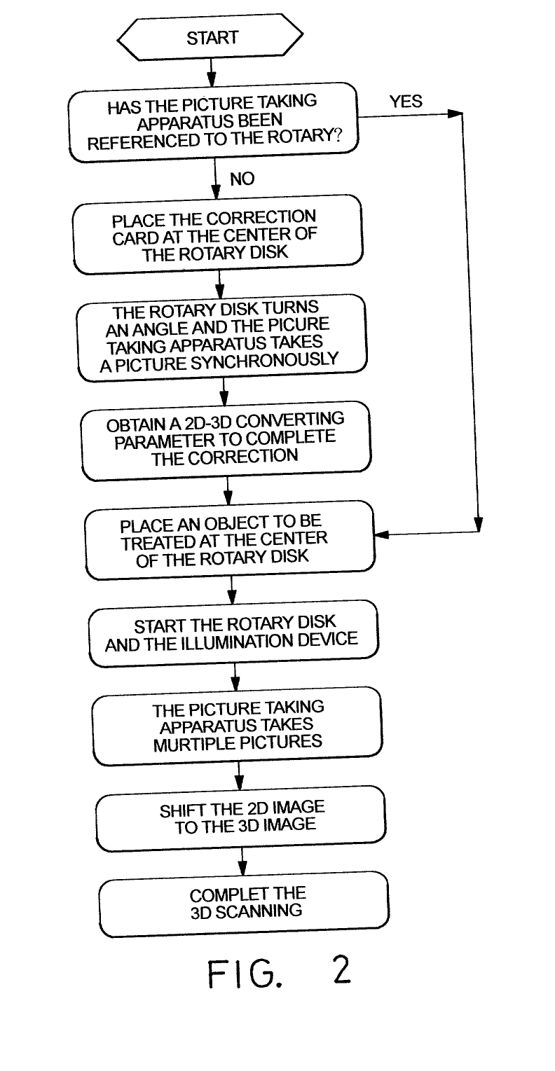

Referring to FIG. 2, while the passive control system for taking a three-dimension picture is in use, the control apparatuses are joined to the digital picture taking apparatus A via the shift interface 11 respectively, and link the rotary disk B via the position interface 21. In the mean time, the control apparatuses can be connected to the illumination devices C via an illumination interface 31 respectively and the object D is placed on the rotary disk B. As soon as the digital picture taking apparatus A starts to scan the object D, a 2D image can be obtained and the 2D image is converted into a three dimensional signal via the 2D-3D converting device 1. In addition, the rotary disk B can rotate a specific angular displacement, such as 30°, on its own axis automatically due to the programmable control after the picture being taken for the digital picture taking apparatus A being able to take a next picture, and the illumination control apparatus 3 is turned on for a best digital image signal.

The digital signal after converted from the picture taking procedure can be input to the CPU/RAM/ROM for being treated into 3D image data so as to be displayed on a computer screen via an image card. Moreover, the 3D image data can be stored in the main memory in the computer directly or saved in a magnetic disk or transmitted by WAN/LAN via a transmission interface.

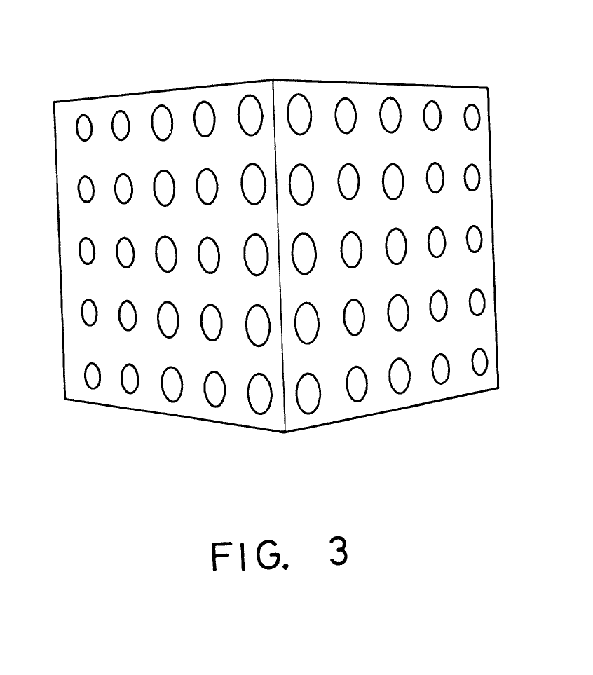

Besides, in order to form an accurate image, a reference step may be added before the passive control system being in operation as shown in FIGS. 2 and 3, that is, the object to be taken picture is treated by the passive control system of the present invention and the 2D image signal obtained is shifted to 3D image signal data, and the 3D image signal data is compared to a standard 3D image data of the object, which is stored in the control system in advance, such that the parameter for the 2D image data shifting to the 3D data can be corrected. The art related to the reference step has been disclosed in the Taiwanese Patent Application No. 89108660 (The patent application has been allowed, the above-mentioned was published on Gazette on Feb. 21st, 2001 under Publication No. 422936.), and the present invention provides a difference from the prior art, i.e., the creation of the present invention is that the passive three-dimensional picture taking method applied in the present invention allows the control system of the present invention to obtain a space coordinates of a cubic model without projecting any light beam instead of the active scanning way used by Taiwanese Patent Application No. 89108660. The innovation of the present invention can avoid a noise signal resulting from the material surface of the scanned object so as to prevent from an erroneous judgment while the light beam projects toward the object during the operation of scanning. The innovation is achieved by way of a cubic correction card as shown in FIG. 3 and the cubic correction card solves inner and outer parameters of the lens pattern of a camera generating from 2D to 3D so that the correspondence problem resulting from the projecting light beam stripes during the active scan. (Please reference to “Machine Vision”, McGraw-Hill Series in Computer Science, by Ramesh Jain, Rangachar Kasturi, Brian G. Schunck, and Rangacher Kasturi, pp293.)

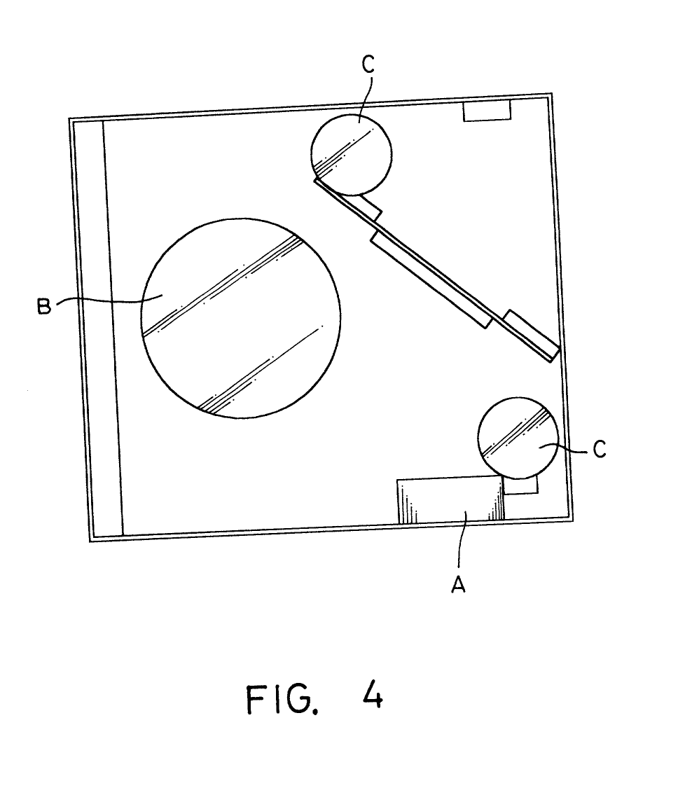

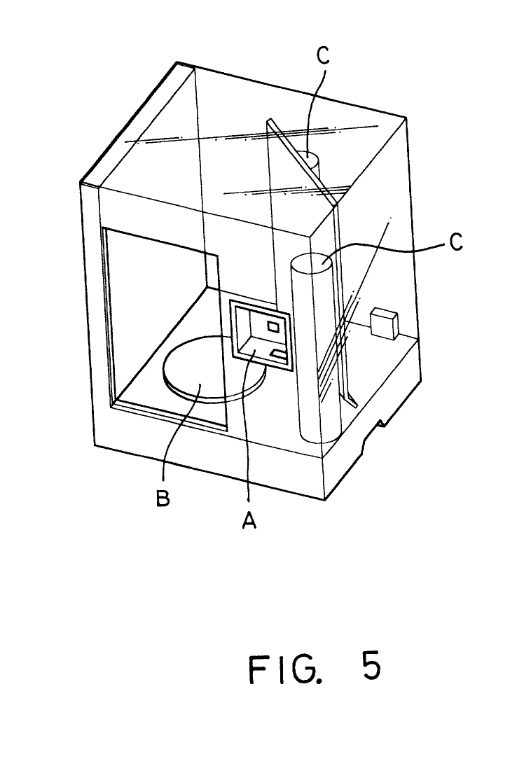

Referring to FIGS. 4 and 5, a plan view and a perspective view of a layout with respect to the hardware used in the present invention based on the preceding description while the passive control system is in practice. It can be seen from the figures that what relationship among the components of the hardware is, however, it is noted that the layout shown is only an explanatory example and not a restriction.

Besides, the image formed by the present invention can be edited such as being modified, deleted, added, moved, and etc. instead of the tedious job of the inconvenient key-in operation.

Therefore, it is appreciated that the operation with regard to a 3D picture taking and an image forming can be conducted automatically by way of the present invention more precisely and more reliably than the manual operation. In addition, the present invention provides further advantages such as the simply operated control system, and the connecting ports with ordinary standard specifications so that it is possible for the present invention suitable for the operation with regard to the picture scanning and taking. These features are not possible for the conventional system can reach effectively.

While the invention has been described with reference to a preferred embodiment thereof, it is to be understood that modifications or variations may be easily made without departing from the spirit of this invention, which is defined in the appended claims.

What is claimed is:

1. A passive control system for taking a three dimensional picture, comprising
a 2D-3D converting device with two ends, one of the ends connecting with a digital picture taking apparatus via a shift interface, the other one of the ends connecting with a data processing center, providing a preset program to regulate the digital picture taking apparatus with a start of scanning at a preset time;
a rotary disk apparatus, providing a positioning interface to connect with a rotary disk, and the rotary disk being able to stay in place after turning a preset angular displace in accordance with the preset program;
whereby, an object to be taken a picture is placed on the rotary disk is taken a picture by the digital picture taking apparatus as soon as the rotary disk is turned the preset angular displacement once; and a 2D signal generated by the digital picture taking apparatus is shifted to a 3D signal by way of the 2D-3D converting device for being treated as a 3D image by the data processing center.

2. The passive control system for taking a three dimensional picture according to claim 1, wherein the passive control system further comprises an illumination control device with an illumination interface to connect with at least an illumination device.

3. The passive control system for taking a three-dimensional picture according to claim 1, wherein each of the interfaces is a USB port, a 1394 port, or a RS232 port.

4. The passive control system for taking a three-dimensional picture according to claim 1, wherein the data processing center is a CPU/RAM/ROM.

5. The passive control system for taking a three-dimensional picture according to claim 1, wherein the angular displacement is 30°.

6. The passive control system for taking a three-dimensional picture according to claim 1, wherein each interface can use a port commonly or a port respectively.

7. The passive control system for taking a three-dimensional picture according to claim 1, wherein the data processing center is mounted in the control system.
